(19) United States
(12) Patent Application Publication
(10) Pub. No.: US 2012/0067308 A1
(43) Pub. Date: Mar. 22, 2012

(54) Internal combustion engine , improvements in design and Efficiency

(76) Inventor: Graeme Harold Newman, Auckland (NZ)

(21) Appl. No.: 13/068,879

(22) Filed: May 24, 2011

(30) Foreign Application Priority Data
Jun. 18, 2010 (NZ) 581724

(51) Int. Cl. F02B 75/22

(52) U.S. Cl. 123/55.2

(57) ABSTRACT

(c) This invention relates to the converting of linear combustion force into rotational force within an internal combustion engine. Most internal combustion engines have a crankshaft, but due to the rotational friction loss and combustion force on a crankshaft at TDC, the current engine configuration has limited efficiency. The current engine takes the full thrust of combustion at TDC whilst trying to rotate a crankshaft. A further disadvantage, is the pistons exert piston slap on both sides of the cylinder bore. The crankshaft also causes friction loss from indirect alignment of the connecting rods.

The present invention, by using central half-shafts linking two opposing pistons, greatly reduces friction loss, whereby lineal force is converted into rotational power by means of sliding cam followers, whereby an outer captive thickwalled tube with machined high lead cam-screws receives this power, which in turn is transferred by a central gear to the drive train.

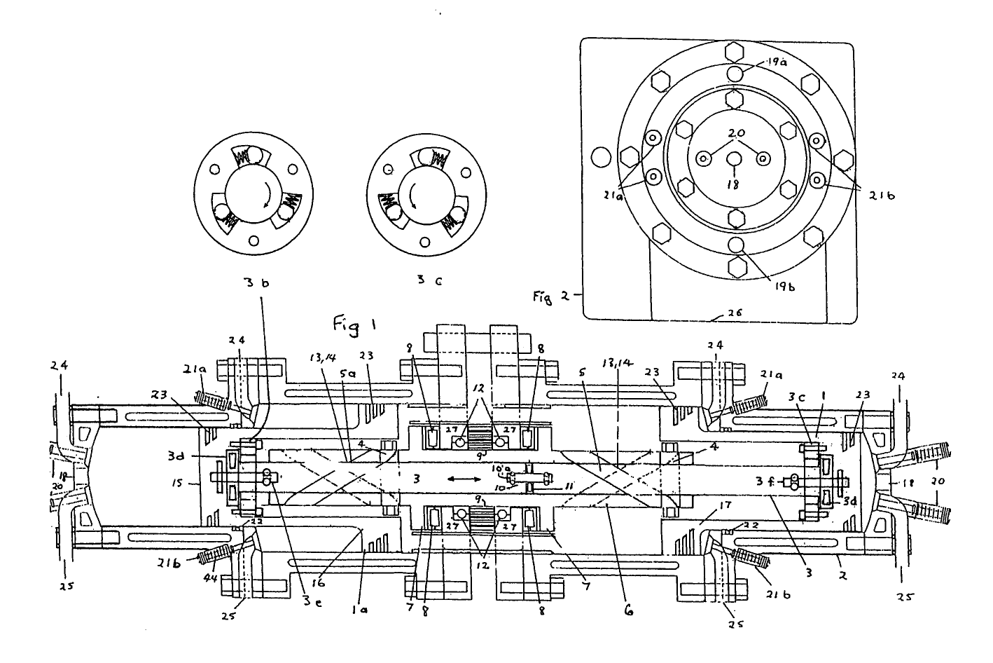

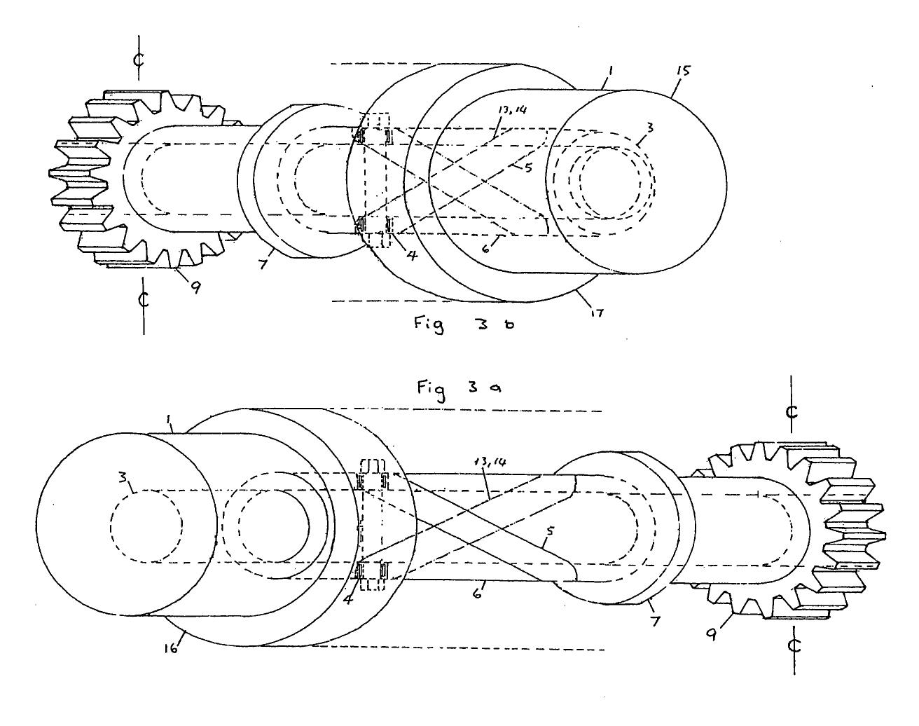

One preferred form of the invention will now be described with reference to the accompanying drawings of which FIG. 1 shows a complete engine in cross-sectional plan view as a horizontally opposed engine with four cylinders. FIG. 2 shows this engine from the end elevation. FIG. 3a, 3b shows the inner workings only, of this engine in two halves, but when joined at C, taken as one. The figures depicted are identical to the cross-sectional plan view. This engine may be of two cylinders or of four or multiples of, when aligned and adjoined beside with a gear or some other connecting device at 9.

In the design shown in FIG. 1, pistons 1, 1a within the cylinders 2, are attached to the central half-shafts at 3, but these same half-shafts are also free to rotate when overrunning, but are driven linearly by the thrust of the piston on its compression stroke, which rotates the dual protruding cam-followers fixed at 90 degrees at 4. The half-shafts are also held linearly by a central pin 10, with locating bearings 10a, with a central thrust bearing 11, to take opposing forces. The overrunning cylindrical roller clutches are shown in a common form at 3b, 3c to designate the principle applied, in 3b as clockwise, and in 3c as anticlockwise. There are alternative spiral-wound, spring-band, overrunning clutches of the V-groove type that are free from drag on their overrunning cycle, that have not been shown here. The roller clutches are held by fastenings to the pistons as shown in 3b, 3c with central pins and bearings at 3e, 3f to allow the half-shafts 3 to rotate, but also to be fixed linearly, with thrust bearings at 3d to take linear thrust. The dual cam-followers 4, follow high lead cam-screws 5, these same cam-screws are machined into a thick-walled tube 6, with rotary projections 7, which is held captive by thrust bearings 8, contained by the engine support 27 and has a central gear fixed to its periphery 9, to transfer power to a drive train. Bearings at 12 are placed to support the rotating thick-walled tube 6 and the thrust from the transfer of power by the gear at 9.

One preferred design is square, i.e. the same stroke as the bore size. Other high lead ratios would work, depending on its co-relation with the bore and stroke sizes and the central shaft diameter.

The preferred design as shown in Drawing FIG. 1, 3a, 3b has two master cylinders, one shown at TDC 1, and one shown at BDC 15. Two slave/stepped pistons are formed as one with their master pistons 16, 17. These pistons reciprocate within their own cylinders. These pistons each have piston rings 23 to seal the induction, compression, combustion and exhaust gases. For a four cylinder design only as FIG. 1 cylinder rings are fitted at 22 to seal the gases for pistons 16, 17. These rings are shown in cross section only.

In operation, various mechanical principles have been observed.

(d) When combustion energy is released within an enclosed chamber, this energy would drive the piston, but would also prevent the piston from rotating. For every action there is an opposite and equal reaction.

(e) This design uses directly opposing pistons to reposition its opposing piston and to enhance the compression of the fuel/air mixture at TDC.

(f) The one piece rotating tube 6, operates as a flywheel also to maintain continuous uninterrupted power.

In the operation of the preferred engine, the combustion of the piston at 1, 1 by the spark plug or glow plug at 18, pushes the central-shaft 3, which in response, rotates the overrunning clutches 3b, 3c, to lock onto the half-shafts with cam-followers attached 4, to rotate the tube 6, which is fixed linearly, by the reaction on the cam-screws 5, rotary power is transferred to the drive-train by a gear 9, fastened to the periphery of the tube at 6. When this piston arrives at BDC an opposing piston has a compressed fuel/air charge ready to be ignited by the dual spark plugs at FIG. 2, 19a, 19b and the attached piston has expelled its exhaust gases. Dual spark or glow plugs would be used for the stepped cylinder ignition.

On combustion, the piston is prevented from rotating by the mass of combustion energy released. This force is transferred by the cam-followers, which in turn rotates the tube by its cam-screw. The opposing central piston half-shaft is free to rotate on its axis as it exhausts spent gases and positions the piston for its next induction stroke. This same piston is free to rotate as it compresses the fuel/air mixture. Dual inlet and exhaust valves are used for the stepped pistons at 21a, 21 b whilst single inlet and exhaust valves are used at 20. Cylinder rings are used at 22. Standard piston rings are used at 23. Inlet and exhaust ports at 24, 25. Oil sump is shown at FIG. 2, 26.

What is claimed is:

1. An internal combustion, horizontally opposed engine that has four pistons acting within four cylinders that are directly inline, whereby the two inner stepped pistons are of larger diameter than the two outer pistons, with each stepped piston being formed as two pistons in one FIG. 1, 1a whereby these pistons operate within stepped cylinder blocks 2, with the two stepped cylinders joined from each opposing side to make one complete cylinder block, whereby the pistons have central half-shafts 3, that are joined at their centres and also at their piston connections, but are free to rotate at the piston connections 3e, 3f and on the axis of the half-shafts 10, 11, whereby linear combustive force is converted into rotational force by this same thrust acting on dual cam-followers 4, attached to and protruding from both half-shafts acting within a thick-walled tube 6, that is fixed linearly but free to rotate, that transfers this rotational force by means of two dual spiral high lead slotted cam-screws 5, 5a which have opposing screws of which their spiral travel would be 180 degrees, more or less, with this same thick-walled tube 6 acting as a flywheel, whereby developed force is transferred to the drive train by means of a more or less centrally located gear 9, fastened to the periphery of the thick-walled tube 6, whereby it will be noted that the pistons are mainly prevented from rotating on their combustion stroke by the compressive forces produced, thereby allowing the overrunning clutches 3b, 3c to clamp onto the half-shafts to produce linear combustive force via the cam-followers 4 acting on the slotted cam-screws 5, 5a which in turn rotate the thick-walled tube 6, to produce rotational power whereby this same piston half-shaft is free to rotate on its return stroke, whereby one of the opposing pistons is exhausted of spent gases, while the other opposing piston compresses the air/fuel mixture in preparation for the next combustion stroke, whereby this sequence is transferred to the opposing side again, whereby it will be seen that this initial startup is begun by air/fuel mixture being inducted at inlet port 24/inlet valve 20, then compressed, in sequence with electrical spark initiation in consequence of an electrical starting motor engaging momentarily by a gear thrusting onto the centrally located gear fastened onto the thick-walled tube at 9.
1) An engine as claimed in claim 1 that requires fewer reduction gears because the thick-walled tube or flywheel 6 has the ability to freewheel between reciprocating strokes.
2) An engine as claimed in claim 1 that has all of the same mechanical operational design features, but has two horizontally opposed pistons and no stepped pistons or stepped cylinder blocks, whereby another twin cylinder is aligned beside this same engine with a gear or some other connecting device at the central gear 9 or an additional twin cylinder may be attached in the same manner to become 6 cylinders.
3) An engine as claimed in claim 1 that has additional cylinder rings FIG. 1, 22 housed into the cylinder to prevent combustion forces from travelling beyond the combustion area of the stepped cylinder.
